(19) United States
(12) Patent Application Publication
(10) Pub. No.: US 2023/0159267 A1
(43) Pub. Date: May 25, 2023

(54) REFUSE BAG LINER SYSTEM AND METHODOLOGY

(71) Applicants: Joseph Apprendi, Montclair, NJ (US); Jerome FitzGibbons, New Orleans, LA (US)

(72) Inventors: Joseph Apprendi, Montclair, NJ (US); Jerome FitzGibbons, New Orleans, LA (US)

(21) Appl. No.: 18/057,332

(22) Filed: Nov. 21, 2022

Related U.S. Application Data
(60) Provisional application No. 63/282,233, filed on Nov. 23, 2021.

(51) Int. Cl. B65F 1/06; B65F 1/00

(52) U.S. Cl. CPC B65F 1/062; B65F 1/0006

(57) ABSTRACT

A refuse liner system for use with a refuse container comprises a cartridge positionable within a refuse container. The cartridge includes an outer casing and a cover mountable with respect to the outer casing. The cover defines a cover passage extending therethrough. The refuse liner system further comprises a plurality of liner bags at least partially disposed in the outer casing. The liner bags are arranged in relation to the cover to permit sequential removal of the liner bags through the cover passage of the cover to enable lining of the refuse container with a selected liner bag.

### CROSS REFERENCE TO RELATED APPLICATION(S)

The present application claims the benefit of, and priority to, provisional Application Serial No. 63/282,233, filed on Nov. 23, 2021, the entire contents of which is incorporated by reference herein.

### BACKGROUND

### 1. Technical Field

The present disclosure relates to a refuse bag liner system, and, more particularly, relates to a low-profile refuse bag liner system capable of storing and sequentially distributing multiple trash bag liners within a trash or refuse container.

### 2. Description of Related Art

Typically, a supply of trash or refuse can liner bags is stored in a residential or commercial facility in a variety of locations including cabinetry, closets and/or other storage components. Storage in various locations leads to searching cupboards and closets to locate the liner supply and requires multiple trips to re-line trash receptacles throughout the facility. In addition, the liner bags are usually packaged in a container or carton, in bulk, presenting obstacles with respect to usage of valuable storage capacity within the facility.

### SUMMARY

Accordingly, the present disclosure is directed to a refuse bag liner system which obviates disadvantages of known trash bag storage methodologies. In accordance with one illustrative embodiment, a refuse liner system for use with a refuse container comprises a cartridge positionable within a refuse container. The cartridge includes an outer casing and a cover mountable with respect to the outer casing. The cover defines a cover passage extending therethrough. The refuse liner system further comprises a plurality of liner bags at least partially disposed in the outer casing. The liner bags are arranged in relation to the cover to permit sequential removal of the liner bags through the cover passage to enable lining of the refuse container with a selected liner bag.

The cover may include a closure member positioned adjacent the cover passage and movable between open and closed conditions.

In certain aspects, the outer casing is configured to be secured to the refuse container. The outer casing includes a base, and the base has a securement member configured to be secured to a surface of the refuse container. The securement member may include an adhesive strip. The adhesive strip may include a first adhesive side for securement to the base of the outer casing and a second adhesive side for securement to the surface of the refuse container.

In other illustrative embodiments, the liner bags are arranged in a coiled configuration in the outer casing of the cartridge. The liner bags may be separate and independent whereby adjacent liner bags are disposed in at least partial overlapping relation. Removal of one liner bag through the cover passage causes a second subsequent liner bag to be at least partially exposed through the cover passage. In other alternate embodiments, the liner bags are connected to each other, and separable along respective score lines.

In certain aspects, each liner bag is folded upon itself to form a plurality of superposed panel portions. Each liner bag may be folded upon itself to form a z-shaped arrangement of panel portions. Other folded arrangements are also contemplated.

In certain embodiments, the cartridge is a single-use cartridge, and disposed upon depletion of the liner bags.

In another illustrative embodiment, the refuse liner system includes an enclosure configured to receive the cartridge and the liner bags and an enclosure lid coupled to the enclosure. The enclosure lid is movable between a first position permitting loading of the cartridge within the enclosure and a second condition enclosing the cartridge within the enclosure. The enclosure lid may be configured to be secured relative to the enclosure when in the second position. A securement member for securing the enclosure to the refuse container may be provided.

The refuse liner system may include at least two cartridges and associated liner bags.

In another illustrative embodiment, a refuse system comprises a refuse container defining a bottom wall and side walls extending from the bottom wall where the side walls are arranged to define a cavity beneath the bottom wall. The bottom wall has a wall passage therethrough for passage of liner bags. A cartridge is at least partially positionable in the cavity beneath the bottom wall of the refuse container. The cartridge has an outer casing and a plurality of liner bags at least partially disposed in the outer casing. The liner bags are arranged in relation to the cover to permit sequential removal of the liner bags through the wall passage of the bottom wall of the refuse container to enable lining of the refuse container with a selected liner bag. The wall passage of the bottom wall of the refuse container may be defined by a plurality of inwardly extending finger projections dimensioned to assist in separation of the individual liner bags.

In another illustrative embodiment of the present disclosure, a method comprises:
positioning a cartridge within a refuse container where the cartridge includes an outer casing and a cover mountable with respect to the outer casing where the cover has a cover passage extending therethrough;
removing an individual liner bag of a plurality of liner bags at least partially disposed in the outer casing through the cover passage; and
lining the refuse container with the individual liner bag.

### BRIEF DESCRIPTION OF THE DRAWINGS

Various embodiments of the present disclosure are described hereinbelow with references to the drawings, wherein:

FIG. 1 is a perspective view illustrating the refuse liner system with a liner bag cartridge being positioned within a refuse container in accordance with one or more illustrative embodiments of the present disclosure.

FIG. 2 is a perspective view illustrating the liner bag cartridge secured to the base of the refuse container in accordance with one or more illustrative embodiments of the present disclosure.

FIGS. 3-5 are perspective views illustrating a sequence of using a liner bag of the liner bag cartridge in association with the refuse container to enclose refuse in accordance with one or more illustrative embodiments of the present disclosure.

FIG. 6 is a perspective view of another embodiment of the refuse liner system including an outer enclosure in an open condition and a liner bag cartridge being positioned within the outer enclosure in accordance with one or more illustrative embodiments of the present disclosure.

FIG. 7 is a perspective view of the refuse liner system illustrating the outer enclosure in a closed condition enclosing the liner bag cartridge in accordance with one or more illustrative embodiments of the present disclosure.

FIG. 8 is a perspective view of the refuse liner system illustrating the cartridge base of the liner bag cartridge and an arranged set of liner bags positioned relative to the cartridge base in accordance with one or more illustrative embodiments of the present disclosure.

FIG. 9 is a perspective view of a packaging system including the outer enclosure and one or more arranged sets of liner bag cartridges positioned within a packaging wrap in accordance with one or more illustrative embodiments of the present disclosure.

FIG. 10 is a perspective view of one methodology of forming the arranged set of liner bags of the liner bag cartridge in accordance with one or more illustrative embodiments of the present disclosure.

FIG. 10A is an enlarged view of the area of detail identified in FIG. 10 illustrating the methodology of folding of the liner bags of the arranged set of liner bags in accordance with one or more illustrative embodiments of the present disclosure.

FIG. 10B is a cross-sectional view illustrating another methodology of folding of the liner bags of the arranged set of liner bags in accordance with one or more illustrative embodiments of the present disclosure.

FIG. 11 is a perspective view of another embodiment of a continuous perforated liner bag set in accordance with one or more illustrative embodiments of the present disclosure.

FIG. 11A is a perspective view of the continuous perforated liner bag set of FIG. 11 illustrating separation of an individual liner bag along a separation line in accordance with one or more illustrative embodiments of the present disclosure.

FIG. 12 is a perspective view of another embodiment of a single use liner bag cartridge in accordance with one or more illustrative embodiments of the present disclosure.

FIG. 13 is a second perspective view of the single use liner bag cartridge of FIG. 12 illustrating a double-sided foam adhesive for securing to the refuse container in accordance with one or more illustrative embodiments of the present disclosure.

FIG. 14 is a perspective view of a packaging system including one or more single use liner bag cartridges of FIGS. 11-13 positioned within a packaging wrap in accordance with one or more illustrative embodiments of the present disclosure.

FIG. 15 is a perspective view of another embodiment of a recyclable single use liner bag cartridge in accordance with one or more illustrative embodiments of the present disclosure.

FIG. 16 is a perspective view of a multiple recyclable single use liner bag cartridge system of FIG. 15 in accordance with one or more illustrative embodiments of the present disclosure.

FIG. 17 is a perspective view of another embodiment of a refuse system including a refuse container defining a lower cavity beneath the refuse container and a cartridge at least partially positionable the lower cavity and having a plurality of liner bags in accordance with one or more illustrative embodiments of the present disclosure.

FIG. 18 is a perspective view of the cartridge of the refuse system of FIG. 17 in accordance with one or more illustrative embodiments of the present disclosure.

### DETAILED DESCRIPTION

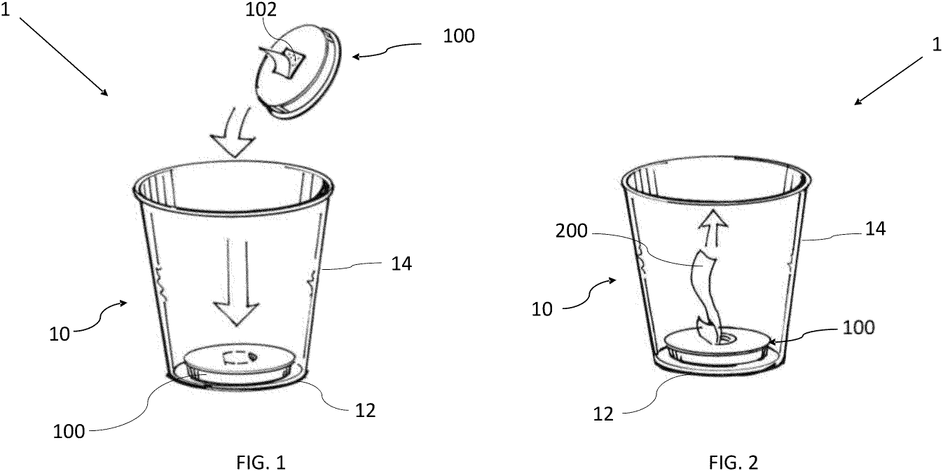

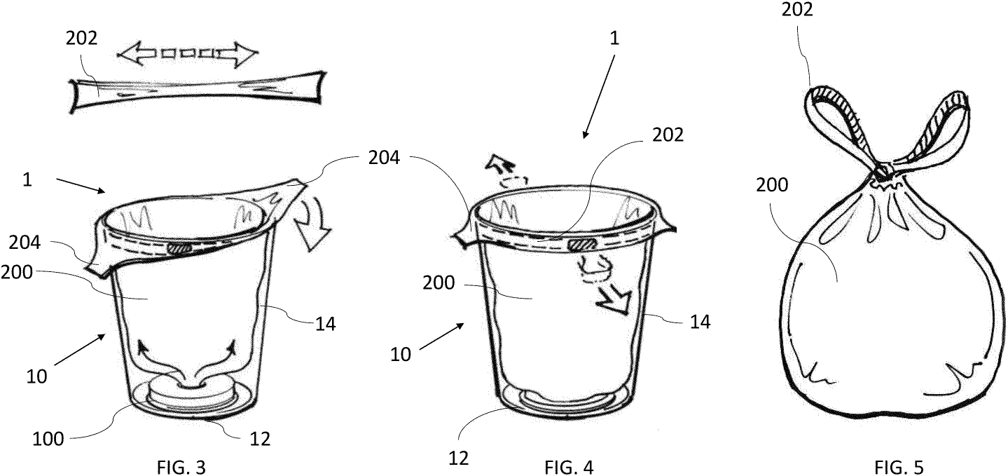

Referring now to the drawing figures wherein like reference numerals identify similar or like components throughout the several views, FIGS. 1-5 illustrate the refuse liner system in accordance with the principles of the present disclosure. The refuse liner system provides a system and methodology for continual supply and storage of trash liner bags for a refuse container. More specifically, the refuse liner system is a sleek, low-profile design, configured to be disposed in a variety of shaped trash or refuse containers including, without limitation, round, square, oblong and oval. Installation of the refuse liner system is quick and easy, typically requiring disposition of a cartridge of the refuse liner system relative to the refuse container, and in illustrative embodiments, securing the cartridge to a surface of the refuse container. In conjunction with the refuse container, the refuse liner system reduces clutter and frees up storage space in cabinetry or the like otherwise used for conventional liner bags and packaging.

FIG. 1 illustrates the refuse liner system 1 in accordance with one illustrative embodiment of the present disclosure. The refuse liner system 1 is intended for use with a refuse container 10 including a bottom wall 12 and side walls 14 extending from the bottom wall 12. Although depicted as tapered in configuration, the refuse container 10 may be any of shape including rectangular, oval, circular etc., and may range in size and height. The refuse liner system 1 includes a cartridge system 100 which, in FIG. 1, is shown being positioned within the refuse container 10. In general, and as depicted in the sequence of operation depicted in FIGS. 2-5, the cartridge system 100 is positioned within the refuse container 100, and in illustrative embodiments, secured to the bottom wall 12 of the refuse container 10. (FIG. 2) Liner bags 200 as a component of the cartridge system 100 are arranged to be individually dispensed from an opening 102 in the cartridge system 100 and positioned to line the refuse container 10 to capture refuse dispensed by one or more users. The liner bags 200 may be individual unattached bags or attached and separated along a score or perforated lines defined between adjacent liner bags 200. The liner bags 200 may include one or more stretchable draw strings 202 to secure the opening of the liner bag 200 prior to or subsequent to its removal from the refuse container 10 as depicted in FIG. 5. The liner bags 200 may include opposing tabs 204 to facilitate engagement by the user, for example, during removal from the cartridge system 100.

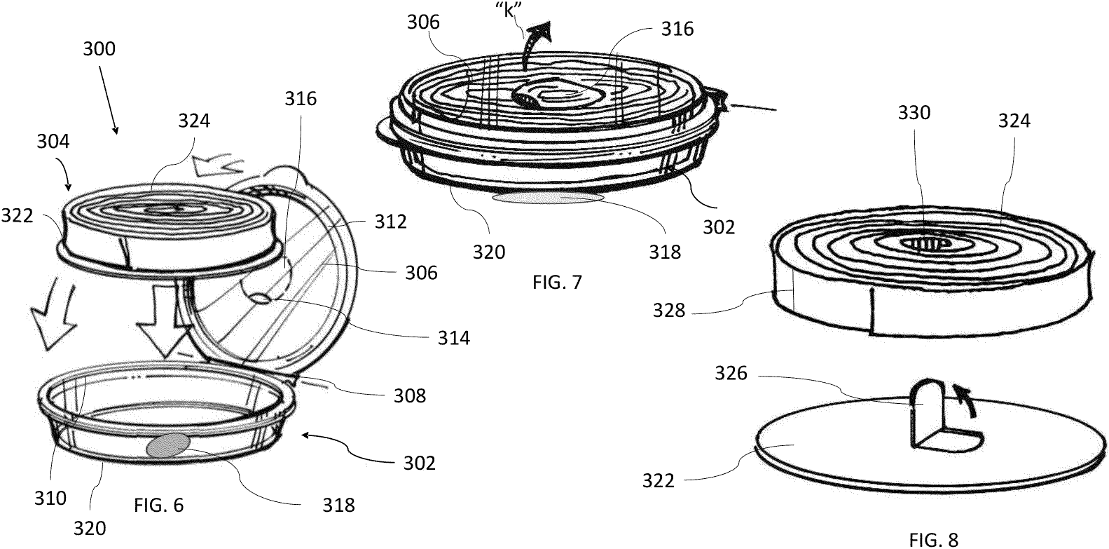

Referring now to FIGS. 6 and 7, one illustrative embodiment of the refuse liner system of the present disclosure will be described. In accordance with this embodiment, the liner system 300 includes an outer enclosure 302 and a cartridge 304 which is positionable within the outer enclosure 302. The outer enclosure 302 has an enclosure lid 306 mounted to the outer enclosure 302. The outer enclosure 302 and the enclosure lid 306 may be fabricated from any suitable material including thermoplastics or the like and molded via conventional thermoforming processes or injection molding techniques. The enclosure lid 306 is pivotally mounted to the outer enclosure 302 along a hinge 308 and is adapted to pivot between a first or open condition (FIG. 6) to permit insertion or removal of the cartridge 304 and a second or closed condition (FIG. 7) enclosing the cartridge 304. The outer enclosure 302 and the enclosure lid 306 include corresponding structure configured to releasably secure the enclosure lid 306 in the second condition. In illustrative embodiments, the outer enclosure 302 includes a peripheral edge 310 and the enclosure lid 306 includes a corresponding inner peripheral ledge 312 which is dimensioned to snap into the peripheral edge 310 (for example, establish a frictional or tolerance fit) to secure the enclosure lid 306 to the outer enclosure 302. Other mechanisms for securing the enclosure lid 306 to the outer enclosure 302 in the second condition are also envisioned.

With continued reference to FIGS. 6 and 7, the enclosure lid 306 of the outer enclosure 302 includes a lid passage 314 in communication with the interior of the outer enclosure 302. The lid passage 314 may take any shape or form and may be, in illustrative embodiments, an opening, slit, port or the like extending through the enclosure lid 306. A flap 316 may be mounted to the enclosure lid 306 and movable to selective cover and expose the lid passage 314. The flap 316 may be adhered to the enclosure lid 306 or be integrally formed with the enclosure lid 306 during manufacture. The flap 316 may be moved in the direction of directional arrow “k” to expose the lid passage 314 and manipulated in the reverse direction to cover the lid passage 312. The flap 316 may include an adhesive or the like at least along a perimeter of the flap 316 to releasably secure to the enclosure lid 306 and cover the lid passage 312.

The liner system 300 is configured, in illustrative embodiments, to be secured to the refuse container 10 (FIG. 1). By securing the liner system 300 to the refuse container 10, the outer enclosure 302 and the cartridge 304 are maintained at the bottom wall 12 of the refuse container 10 presenting a low profile without interfering with disposal of the refuse in the refuse container 10. Moreover, the liner system 300 is readily stored inside the refuse container 10 obviating the need for additional storage capacity to store liner bags in, for example, cabinetry, cupboards or the like. In illustrative embodiments, the liner system 300 includes a securement member, identified schematically by reference numeral 318, in FIGS. 6 and 7. The securement member 318 may be an adhesive strip, for example, a double-sided adhesive strip, with one side secured to the bottom wall 320 of the outer enclosure 302, and the other side secured to the bottom wall 12 of the refuse container 10. (FIG. 2) The adhesive characteristics of the securement member 318 may be selected to sufficiently secure the outer enclosure 302 to the refuse container 10, and also permit removal of the outer enclosure 302 and the cartridge 304 when the liner bags are exhausted. Other securement member 318 types are also envisioned including a bayonet coupling, snap fit, or the like.

With reference to FIGS. 6 and 8, the cartridge 304 includes a cartridge base 322 and a plurality of liner bags 324 supported by the cartridge base 322. The cartridge base 322 may be fabricated from paperboard, cardboard a polymeric material or the like, and may include a center member 326 depending upwardly to facilitate support of the liner bags 324. In illustrative embodiments, the center member 326 is a cut out in the cartridge base 322 which is arranged in the upward position depicted in FIG. 8. The liner bags 324 are arranged in a coiled configuration and are supported by the cartridge base 322. The liner bags 324 may be in the form of plastic disposal bags with or without tie offs. The liner bags 324 may be connected to each other with adjacent liner bags 324 separable along perforated score lines 328 or may be independent and not connected to each other. In the coiled configuration, the center member 326 of the cartridge base 322 is received within an opening 330 formed by the coiled configuration of the liner bags 324 to maintain the liner bags 324 on the cartridge base 322 and permit the liner bags 324 to uncoil upon removal of a selected liner bag 324.

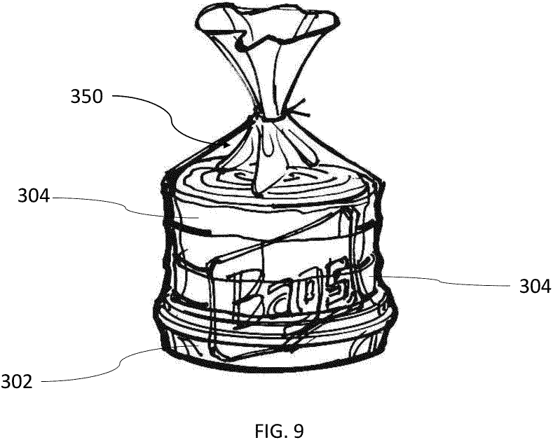

FIG. 9 illustrates an enclosure 302 and a plurality of cartridges 304 packaged with an outer wrap 350 as a replacement kit for supply of the liner system 300. Upon exhaustion of the liner bags 324 from a given cartridge 304, the empty cartridge 304 can be removed by moving the enclosure lid 306 to the open condition, removing the empty cartridge 304 and replacing a new cartridge 304 from the kit into the outer enclosure 302. The enclosure lid 306 may be selectively closed thereby securing the new cartridge 304 with the liner bags 324 within the enclosure 302 for use in the manner discussed hereinabove.

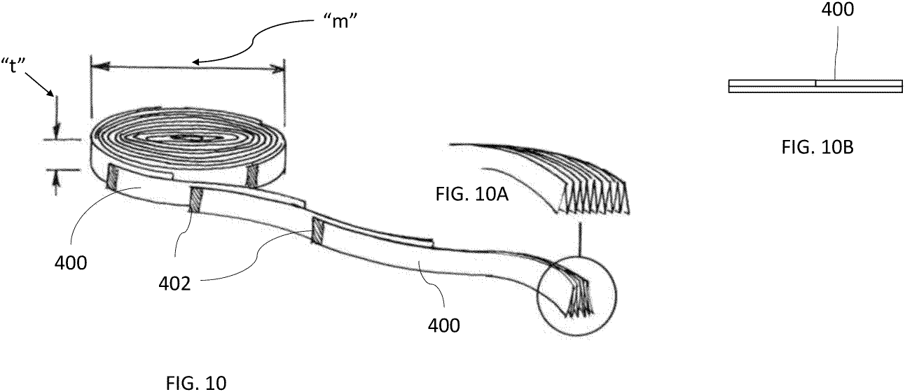

FIG. 10 illustrates an alternate arrangement of liner bags for use with the liner system. In this illustrative embodiment, the liner bags 400 are independent and separate from each other. The liner bags 400 are wrapped in a coiled configuration with adjacent liner bags 400 in at least partial overlapping relation. The liner bags 400 may include drawstrings 402. At least twenty-five (25) liner bags 400 are within the coiled roll although more or less than twenty-five (25) bags are also envisioned. In use, removal of one liner bag 400 through an opening (for example, opening 102 in the cartridge 100 or lid passage 312 of the enclosure lid 306) will cause the next adjacent liner bag 400 to advance via, for example, and without limitation, a frictional relationship established between the overlapping portions of the adjacent liner bags 400 and/or drawstrings 402. In the embodiment depicted in FIG. 10 and in the enlarged isolated view of FIG. 10A, the liner bags 400 are folded upon each other prior to being wrapped in a coil such that the liner bags defined panel portions in superposed or overlapping relation. In one illustrative embodiment, the folding is continuous to form a “z-shaped” configuration or accordion fold. Other folded arrangements are also envisioned such as, for example, a gate fold depicted in FIG. 10B, a twisted configuration, rolled configuration etc.

In illustrative embodiments, the diameter “m” of the rolled liner bags 400 may range from about four (4) to about ten (10) inches, for example, about five (5) inches or about eight (8) inches. The thickness “t” of the rolled liner bags 400 may range from about 0.5 inches to about 1.5 inches, for example, about one (1) inch.

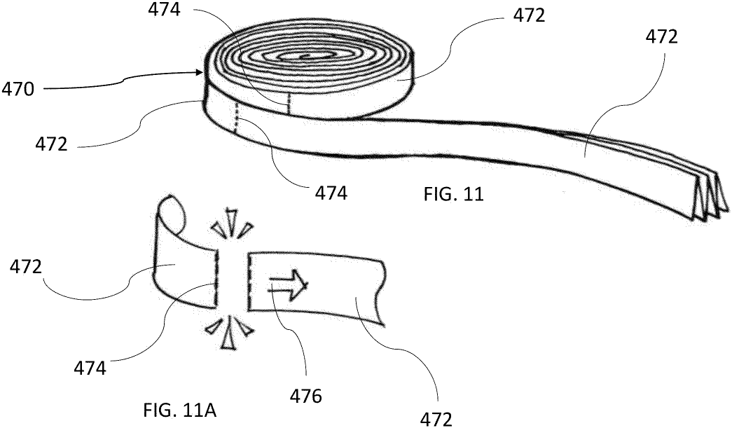

FIGS. 11 and 11A illustrate another embodiment of the of the liner system of the present disclosure. The liner system includes a continuous roll 470 of individual liner bags 472 with adjacent individual liner bags 472 connected to each other along perforated score lines 474. Upon removal of a liner bag 472, through an opening (for example, opening 102 in the cartridge 100 or lid passage 312 of the enclosure lid 306), the liner bag 472 may be separated along the score line 474 through the exertion of separation forces (depicted as reference numeral 476) as depicted in FIG. 11A. In addition, advancement of the given liner bag 472 will cause the next successive liner bag 472 to be presented through the cartridge opening via the connected relationship of the continuous roll 470 of individual liner bags 472.

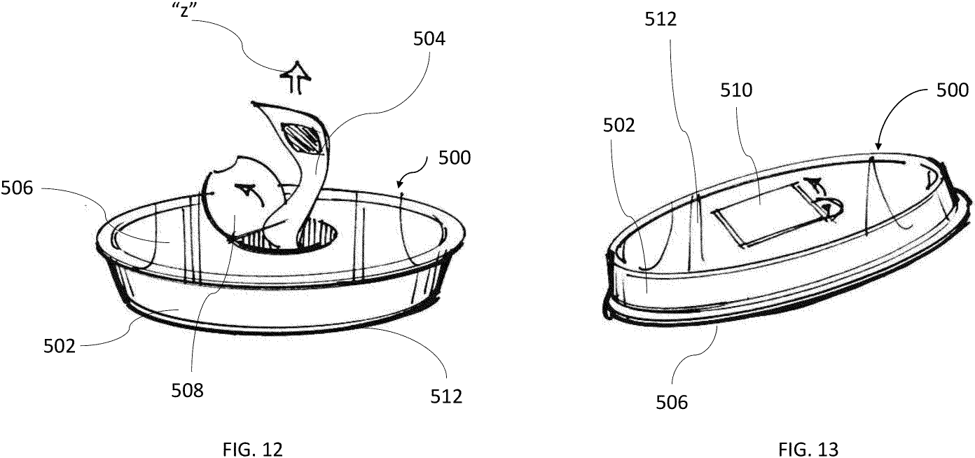

FIGS. 12 and 13 illustrate another illustrative embodiment of the liner system of the present disclosure. In accordance with this embodiment, the liner system 500 is intended for single use application and may be used without the enclosure 302. The liner system 500 includes the cartridge 502 and liner bags 504 disposed within the cartridge 502. The cartridge 502 may include a cover 506 having an openable flap 508 pre-formed in the cover 506 to form a port permitting access to the liner bags 504. The flap 508 moves in the direction of directional arrow “z” to permit access to the liner bags 504. The flap 508 may include an adhesive to secure the flap 508 to the cover if desired. The cartridge 502 may include a securement member 510 secured to the bottom wall 512 of the cartridge 502. The securement member 510 may be an adhesive, for example, a double-sided adhesive or any other securement or fastener capable of releasably securing to the bottom wall 12 of the refuse container 10. Other securement arrangements are also envisioned including, for example, a bayonet coupling, snap fit, etc.

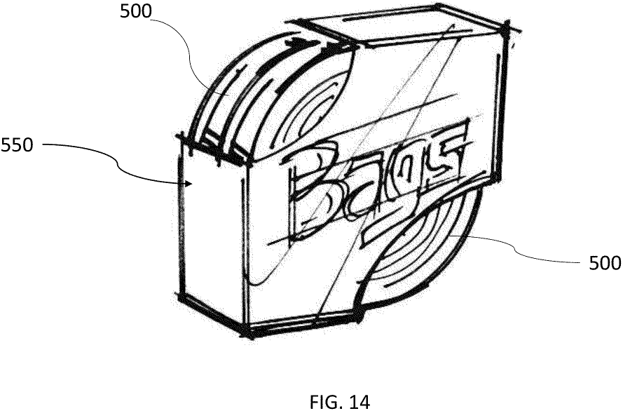

FIG. 14 illustrates the liner system 500 of FIGS. 12 and 13 as part of a kit including multiple cartridges 502 with liner bags 504 enclosed in a carton 550 or the like.

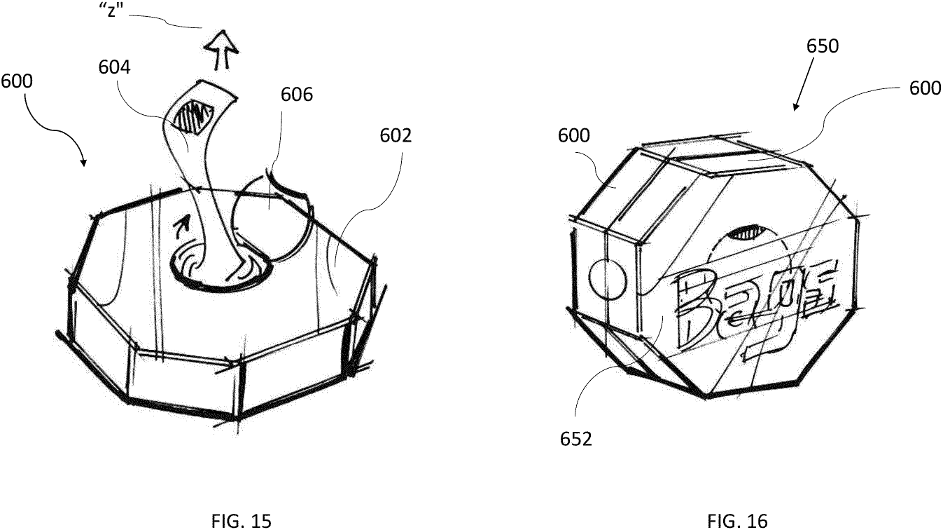

FIG. 15 illustrates a liner system 600 having a cartridge 602 in the form of a folded carton. A trash bag coil or roll 604 contained within the folded carton is accessed via a die-cut, or other port or opening 606. Preferably, double stick adhesive is used to adhere the cartridge to the bottom of the trash can, but other forms of adhesive are within the scope of the invention. The preferred use of pulp or paper in the construction of the folded carton is advantageous to recycling streams, as it can be easily recycled. FIG. 16 illustrates multiple cartridge systems 600 coupled together as a replacement kit 650. The replacement kit 650 may include an outer wrap 652 to enclose the multiple cartridge systems 600.

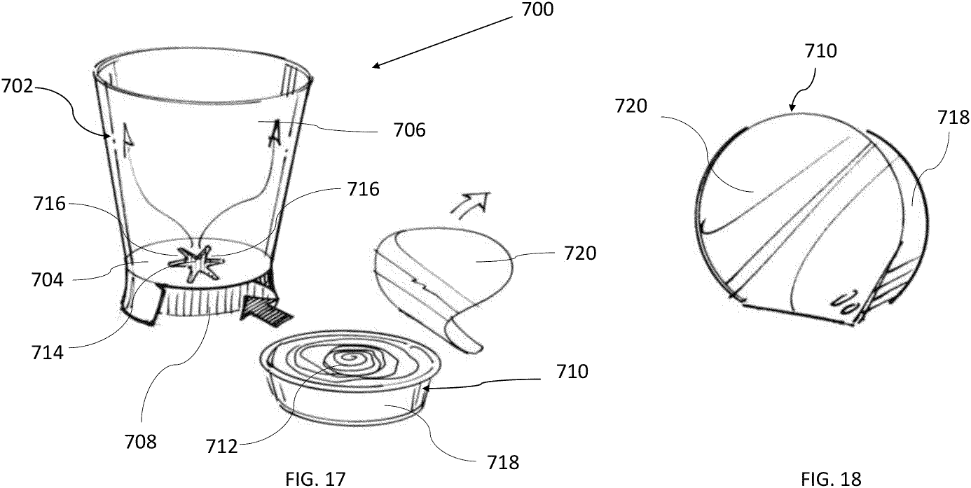

FIGS. 17 and 18 depict another illustrative embodiment of the present disclosure. The system 700 includes refuse container 702 including defining a bottom wall 704 and a side wall(s) 706 extending from the bottom wall 704. The side walls 706 are arranged to suspend the bottom wall 704 to define a cavity 708 beneath the bottom wall 704. A cartridge 710 is at least partially positionable in the cavity 708 beneath the bottom wall 704 of the refuse container 702 and has a plurality of liner bags 712. The bottom wall 704 of the refuse container 702 includes an opening or wall passage 714. In illustrative embodiments, the wall passage 714 is defined by a plurality of inwardly extending finger projections 716 arranged to define a star-finished wall passage 714. The finger projections 716 are configured and dimensioned to assist in separation of the individual liner bags 712 upon withdrawal from the cartridge 710.

The cartridge 710 includes an outer casing 718 and a releasable cartridge cover 720. The liner bags 712 are at least partially disposed in the outer casing 712. The liner bags 712 may be arranged in relation to the wall passage 714 of the refuse container 702 to permit sequential removal of the liner bags 712 through the wall passage 714 of the bottom wall 704 of the refuse container 702 to enable lining of the refuse container 702 with a selected liner bag 712.

In illustrative embodiments, the cartridge system is provided that is a sleek, low-profile, modern design, fitting in various shape trash cans from round to square to oblong to oval. Different sized bags are provided offered to accommodate common-sized trash cans such as a small bathroom, tall kitchen, and full-size. Installation is quick and easy by removing the adhesive backing and sticking to any trash can’s bottom. Working as a system inside the trash can, the cartridge reduces clutter and frees up storage space otherwise used for conventional liner bags and packaging. The cartridge may include features that allow the cartridge to be adhered to the bottom of the trash can such as double stick adhesive, or other types of adhesives, such as, for example, polymer adhesives at base of unit to adhere the cartridge to the bottom of the trash can.

Trash can liner bags are dispensed from a low-profile package adherable to the bottom of various size trash cans. The packaged liner bags are conveniently placed inside the trash can and accessed as needed to re-line the can after removing a filled bag. In addition, the low-profile volume of the packaging requires a minimum amount of space in the bottom of the trash can. Therefore, the bags are folded more times than typically to achieve a low profile when coiled into a roll in the manufacturing process. Each dispenser package will contain a coiled roll of a number of bags, for example, 25 bags, although this number can be greater or smaller. The bags are accessible from an opening or port in the packaging. One type of opening could be, for example, a die-cut port centrally located on the packaging, although other types of openings and configurations are possible. As one liner bag is dispensed from the center of the coil, a subsequent bag will follow, allowing convenient access when needed. Trash bags advance through the access port by the adherence of friction to the previous trash bag. Extra folding of the trash bags creates a space-saving size that can discreetly be placed at the bottom of the trash can. Bags can be accessed and dispensed where they are needed from the trash can itself. Dispensing from the center of the coil allows subsequent trash bags to follow and pre-stage for convenient access. An alternate configuration includes a continuous perforated roll. Each liner bag may optionally include a poly drawstring for tying off when filled. The drawstring, if included may have elasticity conforming to the rim of various size trash cans. Optionally, tabs on either side of the bag may be accessible via opening to pull/tie bag prior to disposal.

In one illustrative embodiment, a cartridge and refill system comprise a refillable clamshell, such as a thermoformed clamshell and trash bag refills in coil or rolls. An integral hinge within the thermoform clamshell, if provided, allows for a one-piece construction, although two-piece constructions are also possible. The clamshell tub and lid using a snap, or other closure can be opened, refilled, and closed numerous times. The clamshell cartridge adheres to the bottom of the trash can via double-stick foam adhesive, or other suitable adhesives. The center access port is preferably achieved as a perforated die-cut. Secondary packaging may contain both a clamshell cartridge and one or more refills.

In another illustrative embodiment, a single-use cartridge system comprises a form-fill-and-seal cartridge. The primary package or cartridge may comprise a thermoformed tub, trash bag coil or roll, and pulp, paper, or plastic lidding material with a die-cut, or other type of access port. Double stick adhesive, or other suitable adhesives are used to adhere the cartridge to the bottom of the trash can.

In yet another illustrative embodiment, a secondary packaging cartridge system comprises a folded carton. A trash bag coil or roll contained within the folded carton is accessed via a die-cut, or other port or opening. Preferably, double stick adhesive is used to adhere the cartridge to the bottom of the trash can, but other forms of adhesive are within the scope of the invention. The preferred use of pulp or paper in the construction is advantageous to recycling streams, as it can be easily recycled.

In one other illustrative embodiment of the present disclosure, a cartridge and trash can system includes a cartridge refill containing trash bags and a purposefully designed trash which work together as a dispensing system. The trash can will have an elevated bottom where a bag cartridge can be slipped under and remain hidden from view. Trash bags are accessed as needed through a hole in the bottom of the trash can. The shape of the dispensing hole will preferably contain finger features that will assist in bag separation as they are dispensed. The refill cartridge construction will preferably be a form-fill-and-seal thermoform with lidding material. Production of the trash can in various manufacturing methods include thermoforming processes, injection molded plastic, stamped and or formed metal, or basket weaving construction in natural or synthetic materials.

In other illustrative embodiments, the liner bags and cartridge packaging may be made from a variety of suitable polymers or other materials including polypropylene, polyethylene or compostable or biodegradable plant-based material, such as, for example, material made from corn. The thermoform cartridge can be made from a variety of suitable polymers or other materials such as, for example, PET recyclable plastic or plant-based materials. The folded carton can be made from cardboard, paperboard, clay coated chipboard or solid bleached sulfate cardboard, or other suitable materials

Although the illustrative embodiments of the present disclosure have been described herein with reference to the accompanying drawings, the above description, disclosure, and figures should not be construed as limiting, but merely as exemplifications of particular embodiments. It is to be understood, therefore, that the disclosure is not limited to those precise embodiments, and that various other changes and modifications may be effected therein by one skilled in the art without departing from the scope or spirit of the disclosure.

What is claimed is:

1. A refuse liner system for use with a refuse container, comprising:
a cartridge positionable within a refuse container, the cartridge including an outer casing and a cover mountable with respect to the outer casing, the cover having a cover passage extending therethrough; and
a plurality of liner bags at least partially disposed in the outer casing, the liner bags arranged in relation to the cover to permit sequential removal of the liner bags through the cover passage of the cover to enable lining of the refuse container with a selected liner bag.

2. The refuse liner system according to claim 1 wherein the cover includes a closure member positioned adjacent the cover passage and movable between open and closed conditions.

3. The refuse liner system according to claim 1 wherein the outer casing is configured to be secured to the refuse container.

4. The refuse liner system according to claim 2 wherein the outer casing includes a base, the base including a securement member configured to be secured to a surface of the refuse container.

5. The refuse liner system according to claim 3 wherein the securement member includes an adhesive strip.

6. The refuse liner system according to claim 5 wherein the adhesive strip includes a first adhesive side for securement to the base of the outer casing and a second adhesive side for securement to the surface of the refuse container.

7. The refuse liner system according to claim 1 wherein the liner bags are arranged in a coiled configuration in the outer casing.

8. The refuse liner system according to claim 7 wherein the liner bags are separate and independent whereby adjacent liner bags are disposed in at least partial overlapping relation.

9. The refuse liner system according to claim 8 wherein removal of one liner bag through the cover passage causes a second subsequent liner bag to be at least partially exposed through the cover passage.

10. The refuse liner system according to claim 8 wherein the liner bags are connected to each other, and separable along respective score lines.

11. The refuse liner system according to claim 8 wherein each liner bag is folded upon itself to form a plurality of superposed panel portions.

12. The refuse liner system according to claim 11 wherein each liner bag is folded upon itself to form a z-shaped arrangement of panel portions.

13. The refuse liner system according to claim 1 wherein the cartridge is a single use cartridge, and disposed upon depletion of the liner bags.

14. The refuse liner system according to claim 1 including an enclosure configured to receive the cartridge and the liner bags and an enclosure lid coupled to the enclosure, the enclosure lid movable between a first position permitting loading of the cartridge assembly within the enclosure and a second condition enclosing the cartridge within the enclosure.

15. The refuse liner system according to claim 14 wherein the enclosure lid is configured to be secured relative to the enclosure when in the second position.

16. The refuse liner system according to claim 14 including at least two cartridges and associated liner bags.

17. The refuse liner system according to claim 14 including a securement member for securing the enclosure to the refuse container.

18. A refuse system, comprising:
a refuse container defining a bottom wall and side walls extending from the bottom wall, the side walls arranged to define a cavity beneath the bottom wall, the bottom wall defining a wall passage therethrough;
a cartridge at least partially positionable cavity beneath the bottom wall of the refuse container, the cartridge including an outer casing; and
a plurality of liner bags at least partially disposed in the outer casing, the liner bags arranged in relation to the cover to permit sequential removal of the liner bags through the wall passage of the bottom wall of the refuse container to enable lining of the refuse container with a selected liner bag.

19. The refuse system according to claim 18 wherein the wall passage of the bottom wall is defined by a plurality of inwardly extending finger projections dimensioned to assist in separation of the individual liner bags.

20. A method, comprising:
positioning a cartridge within a refuse container where the cartridge includes an outer casing and a cover mountable with respect to the outer casing where the cover has a cover passage extending therethrough;
removing an individual liner bag of a plurality of liner bags at least partially disposed in the outer casing through the cover passage; and
lining the refuse container with the individual liner bag.
